(19) United States
(12) Patent Application Publication
(10) Pub. No.: US 2021/0264483 A1
(43) Pub. Date: Aug. 26, 2021

(54) TRANSACTION PRICE PREDICTION DEVICE AND TRANSACTION PRICE PREDICTION METHOD

(71) Applicant: Mitsubishi Electric Corporation, Tokyo (JP)

(72) Inventor: Takahisa HIRATA, Tokyo (JP)

(73) Assignee: Mitsubishi Electric Corporation, Tokyo (JP)

(21) Appl. No.: 17/318,576

(22) Filed: May 12, 2021

Related U.S. Application Data
(63) Continuation of application No. PCT/JP2018/044218, filed on Nov. 30, 2018.

(51) Int. Cl. G06Q 30/02; G06N 5/02; G06N 20/00

(52) U.S. Cl. CPC G06Q 30/0283; G06N 20/00; G06N 5/02

(57) ABSTRACT

A transaction price prediction device uses a first prediction model for predicting a buying bid volume, to thereby predict a buying bid volume on a prediction-target date/time, and uses a second prediction model for predicting a transaction price, to thereby predict a transaction price on the prediction-target date/time.

### CROSS REFERENCE TO RELATED APPLICATIONS

This application is a Continuation of PCT International Application No. PCT/JP2018/044218, filed on Nov. 30, 2018, all of which is hereby expressly incorporated by reference into the present application.

### TECHNICAL FIELD

The present invention relates to a transaction price prediction device and a transaction price prediction method for predicting a commodity transaction price in a wholesale commodity market.

### BACKGROUND ART

In recent years, the wholesale electric power market is becoming active and there is a growing need for prediction of power transaction prices. The execution price and execution volume of power are determined by the intersection point, on the day of bidding, between a selling bid curve that indicates a relationship between a selling bid volume of power and a selling bid price thereof, and a buying bid curve that indicates a relationship between a buying bid volume of power and a buying bid price thereof.

On the other hand, on the market of Japan Electric Power Exchange (hereinafter, referred to as JEPX), an execution system that is called “Blind Single-price Auction System” is employed for the spot market, and bid trends of power are not open to the public. Thus, the bidder cannot grasp the actual conditions of these bid curves on the day of bidding.

In this regard, according to a bid support system described in Patent Literature 1, the bid curves are estimated so that, with respect to the power supply curve and the power demand curve of the market which are given beforehand, the successful bid volume of power, the profit or the sales volume of supply, in the market, becomes maximum. By use of the thus-estimated bid curves, the bidder can predict the transaction price of power even in a market in which bid trends are not open to the public.

### CITATION LIST

### Patent Literature

Patent Literature 1: Japanese Patent

Application Laid-open No. 2005-339527

### SUMMARY OF INVENTION

### Technical Problem

In the case where the bid trends of power are not open to the public, it is not possible to grasp whether or not the bid curves estimated by the bid support system described in Patent Literature 1 reflect a transaction situation on a prediction-target date/time. Thus, there is a problem in which it is not possible to judge the adequacy of the prediction result for the market.

This invention serves to solve the problem as described above, and an object thereof is to provide a transaction price prediction device and a transaction price prediction method which can predict a transaction price that reflects the transaction situation on the prediction-target date/time.

### Solution to Problem

A transaction price prediction device according to the invention comprises: processing circuitry to predict a buying bid volume on a prediction-target date/time, by applying a prediction value about a condition influential on demand on the prediction-target date/time to a first prediction model for predicting a buying bid volume on a basis of a correlation between a buying bid volume and the condition influential on the demand; to predict a transaction price on the prediction-target date/time, by applying the predicted buying bid volume on the prediction-target date/time and the prediction value about the condition influential on the demand on the prediction-target date/time to a second prediction model for predicting a transaction price; to learn a prediction model which predicts a buying bid volume matched with the prediction value about the condition influential on the demand, as the first prediction model, by using information including actual values of respective buying bid volumes and information including actual values about the condition influential on the demand; and to learn a prediction model which predicts a transaction price matched with both a prediction value of a buying bid volume and the prediction value about the condition influential on the demand, as the second prediction model, by using information including the actual values of the respective buying bid volumes, actual values of respective transaction prices and the actual values about the condition influential on the demand.

### Advantageous Effects of Invention

According to the invention, the buying bid volume on the prediction-target date/time is predicted by use of the first prediction model for predicting a buying bid volume, and the transaction price corresponding to the buying bid volume on the prediction-target date/time is predicted by use of the second prediction model for predicting a transaction price. Accordingly, it is possible to predict a transaction price that reflects the transaction situation on the prediction-target date/time.

### BRIEF DESCRIPTION OF DRAWINGS

FIG. 1 is a block diagram showing a configuration example of a transaction price prediction device according to Embodiment 1.

FIG. 2 is a flowchart showing a transaction price prediction method according to Embodiment 1.

FIG. 3 is a diagram showing an example of a first prediction model according to Embodiment 1.

FIG. 4 is a diagram showing an example of a second prediction model according to Embodiment 1.

FIG. 5 is a diagram showing an example of a manner of presenting a prediction result, according to Embodiment 1.

FIG. 6A is a block diagram showing a hardware configuration for implementing functions of the transaction price prediction device according to Embodiment 1.

FIG. 6B is a block diagram showing a hardware configuration for executing software which can implement the functions of the transaction price prediction device according to Embodiment 1.

### DESCRIPTION OF EMBODIMENTS

### Embodiment 1

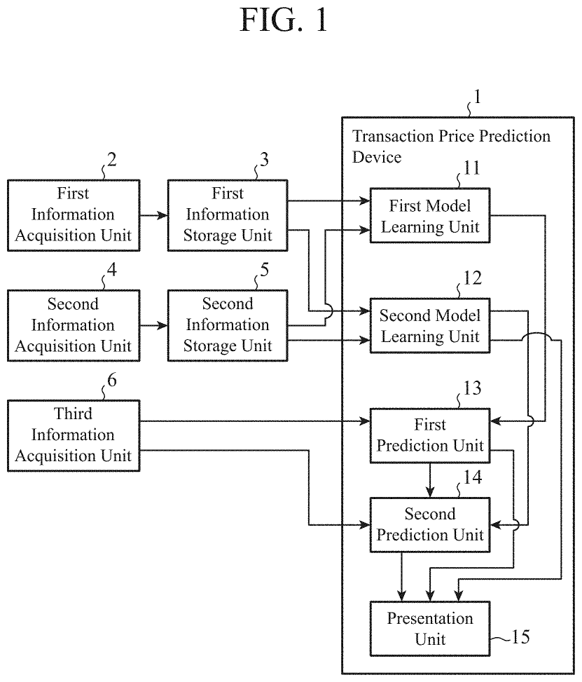

A transaction price prediction device and a transaction price prediction method according to Embodiment 1 are applicable to prediction of transaction prices of various commodities for which selling and buying bids are performed in a market. Hereinafter, a case will be described where an execution price of power in the spot market of JEPX on a prediction-target date/time is predicted by use of the transaction price prediction device and the transaction price prediction method according to Embodiment 1. FIG. 1 is a block diagram showing a configuration example of a transaction price prediction device 1 according to Embodiment 1. The transaction price prediction device 1 uses a first prediction model to thereby predict a buying bid volume on the prediction-target date/time, and uses a second prediction model to thereby predict an execution price of power on the prediction-target date/time.

The first prediction model is a prediction model that is learned using first information and second information in order to predict a buying bid volume. The first information is transaction information including actual values of buying bid volumes, and indicates, for example, the total buying bid volumes and execution prices of power which are obtained before the prediction-target date/time, and which are made open in the spot market of JEPX. A first information acquisition unit 2 acquires the first information and stores it in a first information storage unit 3. The first information acquisition unit 2 may be a communication device that acquires the first information via a communication line, such as the Internet, or may be an input device that receives a manual input of the first information made by a user.

The second information is information indicative of actual values about a condition that is influential on the bid, and is, for example, information influential on the power demand, such as, meteorological information, calendar information, power-generator operation information and the like, obtained before the prediction-target date/time. Examples of the meteorological information include an air temperature, weather information and an amount of sunlight. The calendar information is a date on which the power demand is expected to increase or decrease, and is exemplified by a public holiday and a business day of a company with a large power demand. The power-generator operation information is information indicative of whether or not the power generator is stopped due to, for example, a periodic inspection, a failure or an accident. Further, presence/absence of the disconnection of an interconnection line that connects the power systems together, may be included in the second information.

A second information acquisition unit 4 acquires the second information and stores it in a second information storage unit 5. The second information acquisition unit 4 may be a communication device that acquires the second information via a communication line, such as the Internet, or may be an input device that receives a manual input of the second information made by a user. Further, the first information storage unit 3 and the second information storage unit 5 are storage devices from which the transaction price prediction device 1 can read out information.

The second prediction model is a prediction model that is learned using buying bid volumes and the second information in order to predict an execution price (i.e. transaction price) of power. When third information is applied to the second prediction model, an execution price of power on the prediction-target date/time is predicted. The third information is a prediction value about a condition that is influential on the demand on the prediction-target date/time, and although the item of the condition is in common with the second information, the third information differs therefrom in that it is prediction information on the prediction-target date/time. Examples of the third information include, for example, meteorological forecast information, calendar information and power-generator operation planning information on the prediction-target date/time. A third information acquisition unit 6 may be a communication device that acquires the third information via a communication line, such as the Internet, or may be an input device that receives a manual input of the third information made by a user.

As shown in FIG. 1, the transaction price prediction device 1 includes a first model learning unit 11, a second model learning unit 12, a first prediction unit 13, a second prediction unit 14 and a presentation unit 15. The first model learning unit 11 learns the first prediction model by using the first information and the second information. The first prediction model is a prediction model used for predicting a buying bid volume of power on the prediction-target date/time. Using the first information read out from the first information storage unit 3 and the second information read out from the second information storage unit 5, the first model learning unit 11 learns the first prediction model.

The second model learning unit 12 learns the second prediction model by using the first information and the second information. The second prediction model is a prediction model used for predicting an execution price of power on the prediction-target date/time. Using the first information read out from the first information storage unit 3 and the second information read out from the second information storage unit 5, the second model learning unit 12 learns the second prediction model.

The first prediction unit 13 applies the third information to the first prediction model to thereby predict the buying bid volume of power on the prediction-target date/time. For example, the first prediction unit 13 applies the third information on the prediction-target date/time acquired by the third information acquisition unit 6, to the first prediction model learned by the first model learning unit 11, to thereby predict the buying bid volume of power on the prediction-target date/time.

The second prediction unit 14 applies the buying bid volume predicted by the first prediction unit 13 and the third information to the second prediction model, to thereby predict the execution price of power on the prediction-target date/time. For example, the second prediction unit 14 applies the buying bid volume of power predicted by the first prediction unit 13 and the third information acquired by the third information acquisition unit 6, to the second prediction model learned by the second model learning unit 12, to thereby predict the execution price of power on the prediction-target date/time.

The presentation unit 15 presents the second prediction model, the buying bid volume predicted by the first prediction unit 13 and the execution price predicted by the second prediction unit 14. For example, the presentation unit 15 displays on a display unit not shown in FIG. 1, a probability distribution of the prediction values about the buying bid volume of power and a probability distribution of the prediction values about the execution price of power, together with the second prediction model used for predicting the execution price of power. Further, the presentation unit 15 may display the third information and the first prediction model used for predicting the buying bid volume, on the display unit.

It is noted that, in FIG. 1, the first model learning unit 11, the second model learning unit 12 and the presentation unit 15 may instead be provided in an external device different from the transaction price prediction device 1.

Namely, the transaction price prediction device 1 may omit to include the first model learning unit 11, the second model learning unit 12 and the presentation unit 15, and may perform prediction upon receiving the prediction models learned by the first model learning unit 11 and the second model learning unit 12 included in the external device, and then transmit the prediction results and the prediction model/models to the external device, to thereby cause the presentation unit 15 to present them. Further, the display unit for displaying the prediction results and the prediction model/models may be included in the transaction price prediction device 1, or may be provided in an external device different from the transaction price prediction device 1.

Next, the operation will be described.

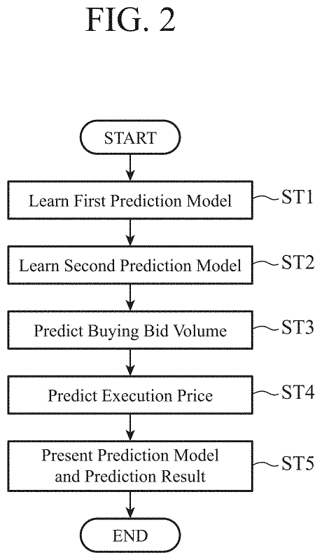

FIG. 2 is a flowchart showing a transaction price prediction method according to Embodiment 1.

First, the first model learning unit 11 learns the first prediction model (Step ST1). For example, the first model learning unit 11 acquires from the first information storage unit 3, the first information including each buying bid volume of power and the corresponding execution price, together with the date/time on which the corresponding bid is made. It is desired that the date/time on which the buying bid volume and the execution price are obtained is a date/time whose condition influential on the bid for power, for example, a condition influential on the power demand, is expected to be similar to that of the prediction-target date/time. For example, the date/time may be a date/time within the nearest week of the prediction-target date/time, or a date/time in the same month of the last year as the prediction-target date/time. A date/time whose condition influential on the power demand is expected to be similar to that of the prediction-target date/time may be determined from the calendar information. In the following description, each date/time whose first information is acquired by the first model learning unit 11 will be referred to as a “similar date/time”.

Subsequently, the first model learning unit 11 acquires the second information on the similar date/time, together with the corresponding date/time, from the second information storage unit 5. For example, meteorological information, calendar information and power-generator operation information on the similar date/time are acquired as the second information.

The first model learning unit 11 associates the first information and the second information with each other by using, as a key, the date/time on which each piece of information is obtained, and then learns the first prediction model by using these pieces of information. The first prediction model is a model for predicting a buying bid volume of power by using, as an explanatory variable, a condition influential on the power demand. For example, the first prediction model may be a simple prediction model as represented by the following formula (1). Using the actual values of the first information and the second information on the similar dates/times, the first model learning unit 11 learns the values of a parameter α1 and a parameter α2 included in the following formula (1). As the learning method of the first prediction model, there is a linear regression method as a simplest method; however, a support vector regression method, a Bayesian regression method and a learning method other than these may be used.

Buying Bid Volume=α1+α2×Air Temperature (1)

On the other hand, as a result of investigation on the bid trends in the power market, the inventor of this application has found out that, in the power market, the buying bid volume of power has a high correlation with the power demand. The first prediction model is a prediction model based on this finding. Further, in consideration of an error between the actual value about a condition influential on the power demand on the prediction-target date/time and the third information as a prediction value about the same item of that condition, the first model learning unit 11 may learn a first prediction model that predicts the buying bid volume of power in a form of a probability distribution.

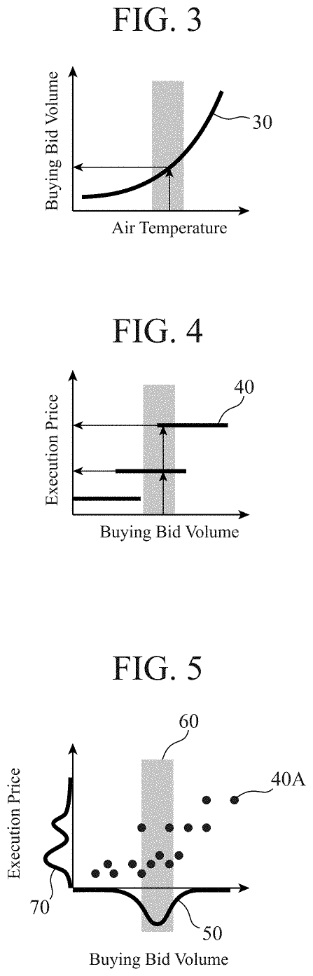

FIG. 3 is a diagram showing an example of a first prediction model 30 according to Embodiment 1. The first prediction model 30 shown in FIG. 3 is a model that has learned about the air temperature-dependent variation of the buying bid volume of power, and predicts the buying bid volume corresponding to the prediction value about the air temperature on the prediction-target date/time. For example, when the air temperature rises, the utilization rate of air-conditioners for cooling becomes higher, so that the power demand increases. If the power demand increases, the bidder desires to surely get the power, so that the buying bid volume also increases. On the other hand, when the air temperature drops to a temperature at which no cooling is necessary, the utilization rate of air-conditioners for cooling becomes lower, so that the power demand decreases and accordingly, the buying bid volume of power also decreases.

Then, the second model learning unit 12 learns the second prediction model (Step ST2). For example, the second model learning unit 12 acquires from the first information storage unit 3, each set of a buying bid volume of power and the corresponding execution price, together with the date/time on which the corresponding bid is made. Here, the first information acquired by the second model learning unit 12 is information obtained on the same dates/times (similar dates/times) as those of the first information and the second information acquired by the first model learning unit 11.

Subsequently, the second model learning unit 12 acquires pieces of the second information on the similar dates/times, together with the respective dates/times, from the second information storage unit 5. Namely, the second information acquired by the second model learning unit 12 is information obtained on the same dates/times as those of the first information and the second information acquired by the first model learning unit 11.

It is noted that, examples of the condition influential on the power demand in the power market include a utilization rate of cooling apparatuses and a crude oil price, other than the meteorological information, etc. described previously. However, generally, the crude oil price varies moderately as compared to the utilization rate of cooling apparatuses. Thus, in the case where the second model learning unit 12 acquires the crude oil price as the second information, the crude oil price is not necessarily that which is obtained on a date/time that is the same as that of the second information acquired by the first model learning unit 11. For example, it may be a crude oil price that is obtained in the nearest one year period. Namely, in the information indicative of conditions influential on the power demand, moderately variable information (for example, whose variation amount in a fixed period is less than a threshold value) does not have to be that which is obtained on a date/time that is the same as that of the second information acquired by the first model learning unit 11, so long as it is obtained in a period where the variation is expected to be in the allowable range.

The second model learning unit 12 associates the buying bid volume and execution price of power acquired as the first information and the second information with each other by using, as a key, the date/time on which each piece of information is obtained, and then learns the second prediction model by using these pieces of information. The second prediction model is a model for predicting an execution price of power by using, as explanatory variables, a buying bid volume of power and the second information. With respect to a learning method of the second prediction model, the relationship between buying bid volumes of power and execution prices may be learned, for example, in such a manner that the distribution of the execution prices relative to the buying bid volumes is represented by a histogram. Instead, the relationship between buying bid volumes and execution prices may be learned in such a manner that the distribution of the execution prices relative to the buying bid volumes is represented by using a probability density estimation method. For learning the second prediction model, a linear regression method, a support vector regression method, a Bayesian regression method and a learning method other than these may be used.

Further, the second model learning unit 12 may select, using the second information, other information to be used for learning the second prediction model. For example, the second model learning unit 12 selects from the first information, a part of the first information corresponding to a part of the second information used for narrowing, and then uses the selected part of the first information for learning the second prediction model. The part of the second information used for narrowing may be information which is included in the second information on the similar date/time, and which is estimated to be similar to the condition on the prediction-target date/time. For example, among the sets of the buying bid volumes of power and the execution prices that are acquired as the first information, each set selected using the part of the second information for narrowing is used for the calculation of the histogram described above.

As a result of investigation by the inventor of this application on the bid trends of power in the power market, knowledge is obtained that, in the power market, the execution price of power varies non-continuously, in a stepwise manner, relative to the buying bid volume, and a case may arise where multiple execution prices are set for the same buying bid volume. This means that the multiple execution prices correspond discretely to a given buying bid volume. The second prediction model is learned using a learning method by which how the multiple discrete execution prices correspond, with their appropriate probabilities, to the buying bid volume of power, can be expressed. Thus, a relational formula that represents the second prediction model is expected to be complex. However, in the case where the second prediction model is made to approximate to a simple relational formula like that of the first prediction model, the second prediction model can be expressed, for example, by a formula: Transaction Price=α1+α2×Buying Bid Volume. In this case, using the first information and the second information, the second model learning unit 12 learns the value of the parameter α1 and the value of the parameter α2.

FIG. 4 is a diagram showing an example of a second prediction model 40 according to Embodiment 1. The second prediction model 40 shown in FIG. 4 indicates a relationship where the execution price varies non-continuously, in a stepwise manner, relative to the buying bid volume of power. Further, as indicated by arrows in FIG. 4, there is a case where multiple execution prices are predicted for the same buying bid volume. Note that, in consideration of an error between the actual condition on the prediction-target date/time and the third information and an error between the buying bid volume predicted by the first prediction model and the actual buying bid volume on the prediction-target date/time, the second model learning unit 12 may learn a second prediction model that predicts the execution price of power in a form of a probability distribution.

Description will return to FIG. 2.

The first prediction unit 13 predicts the buying bid volume of power on the prediction-target date/time (Step ST3). For example, the first prediction unit 13 applies the third information on the prediction-target date/time acquired by the third information acquisition unit 6 to the first prediction model learned by the first model learning unit 11, to thereby predict the buying bid volume of power on the prediction-target date/time. Further, the first prediction unit 13 may calculate concurrently, using the first prediction model, a probability distribution of the prediction values about the buying bid volume of power on the prediction-target date/time.

The second prediction unit 14 predicts the execution price of power on the prediction-target date/time (Step ST4). For example, the second prediction unit 14 acquires the third information on the prediction-target date/time from the third information acquisition unit 6 and acquires the buying bid volume of power predicted by the first prediction unit 13, and then applies these pieces of information to the second prediction model, to thereby predict the execution price of power on the prediction-target date/time. Further, the second prediction unit 14 may calculate concurrently, using the second prediction model, a probability distribution of prediction values about the execution price of power on the prediction-target date/time.

The presentation unit 15 presents the prediction model and the prediction results (Step ST5). For example, the presentation unit 15 causes the display unit to display: the second prediction model that predicts the execution price of power; the buying bid volume of power on the prediction-target date/time that is predicted by the first prediction unit 13; and the execution price of power on the prediction-target date/time that is predicted by the second prediction unit 14. Further, the presentation unit 15 may cause the display unit to display the first prediction model used for predicting the buying bid volume of power, together with the buying bid volume as a prediction result.

Since the execution price of power varies discretely relative to the buying bid volume, it is difficult to present the execution price of power by a representative value(s), such as an average value or variance values. Accordingly, the presentation unit 15 may visualize the correspondence relationship between the second prediction model, the probability distribution of the buying bid volume of power and the probability distribution of the execution price of power, to thereby perform presentation so that the process of deriving the probability distribution of the execution price from the probability distribution of the buying bid volume by using the second prediction model is recognizable.

FIG. 5 is a diagram showing an example of the manner of presenting the prediction results, according to Embodiment 1. As shown in FIG. 5, the presentation unit 15 plots the prediction values 40A about the execution price of power calculated using the second prediction model, on a graph for indicating a relationship between the buying bid volume of power and the execution price of power, so that the second prediction model is visualized. By referring to the graph shown in FIG. 5, the bidder can recognize that the prediction value 40A about the execution price of power varies discretely relative to the buying bid volume.

Furthermore, the presentation unit 15 puts on the graph shown in FIG. 5, a probability distribution 50 of the buying bid volume of power predicted by the first prediction unit 13, a stripe area 60 indicating a mainly-distributed region of the buying bid volume of power, and a probability distribution 70 of the execution price of power predicted by the second prediction unit 14. Accordingly, when the graph shown in FIG. 5 is displayed on the display unit, the probability distribution 50 of the buying bid volume of power and the probability distribution 70 of the execution price of power are visualized.

By referring to the stripe area 60 put on the graph shown in FIG. 5, the bidder can recognize that the probability distribution 70 of the execution price of power is derived from the prediction values 40A about the execution price included in the stripe area 60. The distribution density of the prediction values 40A about the execution price predicted using the second prediction model, may be displayed using level lines or shades of color. Further, the first prediction model as shown in FIG. 3 may be put on the graph shown in FIG. 5.

In this manner, the transaction price prediction device 1 visualizes the second prediction model used for predicting the execution price of power, the prediction value about the buying bid volume of power and the prediction value about the execution price of power, and performs presentation so that the process of deriving the probability distribution of the execution price from the probability distribution of the buying bid volume by using the second prediction model is recognizable. Accordingly, even in a market in which bid trends are not open to the public, such as, the spot market of JEPX or the like, the bidder can recognize a transaction situation which determines the transaction price of a prediction result, and thus can judge the adequacy of the prediction result.

It is noted that the processing in steps from Step ST1 to Step ST5 shown in FIG. 2 may be executed as continuous processing. Instead, it is allowed that the first prediction unit 13 or the second prediction unit 14 invokes the first prediction model or the second prediction model that is prepared beforehand, whereby prediction processing of each unit is executed asynchronously. Learning processing of the prediction models may be executed recursively in response to a change in the information narrowing condition used for learning, and prediction-value calculation processing may be executed recursively in response to a change in the prediction value.

Further, in the case where the transaction price prediction device 1 consists of the first prediction unit 13 and the second prediction unit 14 as described previously, the transaction price prediction device 1 executes the processing of Step ST3 and the processing of Step ST4 in the flowchart shown in FIG. 2. Namely, the transaction price prediction method according to Embodiment 1 includes: a step in which the first prediction unit 13 predicts the buying bid volume on the prediction-target date/time, by using the first prediction model; and a step in which the second prediction unit 14 predicts the transaction price on the prediction-target date/time, by using the second prediction model.

Next, description will be made about hardware configurations for implementing the functions of the transaction price prediction device 1.

The functions of the first model learning unit 11, the second model learning unit 12, the first prediction unit 13, the second prediction unit 14 and the presentation unit 15 in the transaction price prediction device 1, are implemented by a processing circuit. Namely, the transaction price prediction device 1 includes a processing circuit for executing processing from Step ST1 to Step ST5 shown in FIG. 2. Although the processing circuit may be dedicated hardware, it may be a Central Processing Unit (CPU) which executes programs stored in a memory.

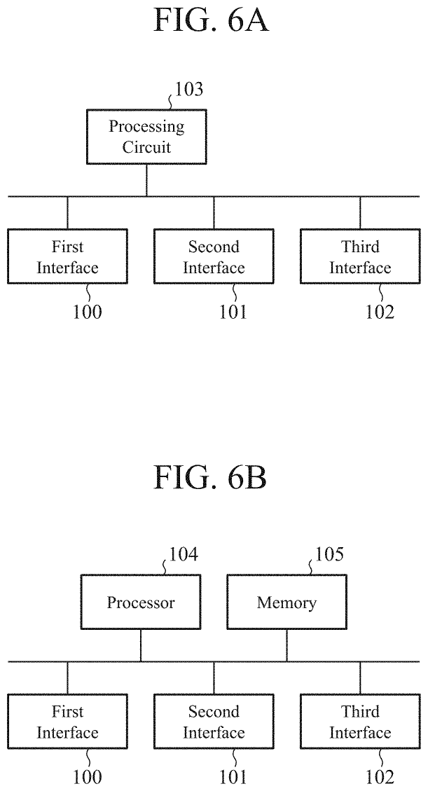

FIG. 6A is a block diagram showing a hardware configuration for implementing the functions of the transaction price prediction device 1. FIG. 6B is a block diagram showing a hardware configuration for executing software which can implement the functions of the transaction price prediction device 1. In FIG. 6A and FIG. 6B, a first interface 100 is an interface for relaying information exchanges between the transaction price prediction device 1 and the storage devices which implement the first information storage unit 3 and the second information storage unit 5. A second interface 101 is an interface for relaying information exchanges between the transaction price prediction device 1 and the communication device or the input device which implements the third information acquisition unit 6. A third interface 102 is an interface for outputting the prediction results outputted from the transaction price prediction device 1 to a display device.

When the processing circuit is a processing circuit 103 as dedicated hardware shown in FIG. 6A, what corresponds to the processing circuit 103 is, for example, a single circuit, a composite circuit, a programmed processor, a parallel-programmed processor, an Application Specific Integrated Circuit (ASIC), a Field-programmable Gate Array (FPGA) or any combination thereof. The functions of the first model learning unit 11, the second model learning unit 12, the first prediction unit 13, the second prediction unit 14 and the presentation unit 15 in the transaction price prediction device 1, may be implemented by their respective processing circuits, or these functions may be implemented collectively by one processing circuit.

When the processing circuit is a processor 104 shown in FIG. 6B, the functions of the first model learning unit 11, the second model learning unit 12, the first prediction unit 13, the second prediction unit 14 and the presentation unit 15 in the transaction price prediction device 1, are implemented by software, firmware or a combination of software and firmware. Note that the software or the firmware is written as a program(s) and stored in a memory 105.

The processor 104 reads out and executes programs stored in the memory 105 to thereby implement the functions of the first model learning unit 11, the second model learning unit 12, the first prediction unit 13, the second prediction unit 14 and the presentation unit 15 in the transaction price prediction device 1. Namely, the transaction price prediction device 1 is provided with the memory 105 for storing the programs by which, when they are executed by the processor 104, the processing from. Step ST1 to Step ST5 in the flowchart shown in FIG. 2 is eventually executed. These programs cause a computer to execute steps or processes of the first model learning unit 11, the second model learning unit 12, the first prediction unit 13, the second prediction unit 14 and the presentation unit 15 in the transaction price prediction device 1. The memory 105 may be a computer-readable storage medium in which stored are programs for causing the computer to function as the first model learning unit 11, the second model learning unit 12, the first prediction unit 13, the second prediction unit 14 and the presentation unit 15 in the transaction price prediction device 1.

What corresponds to the memory 105 is, for example, a non-volatile or volatile semiconductor memory such as a Random Access Memory (RAM), a Read Only Memory (ROM), a flash memory, an Erasable Programmable Read Only Memory (EPROM), an Electrically-EPROM (EEPROM) or the like; a magnetic disc; a flexible disc; an optical disc; a compact disc; a mini disc; a DVD; or the like.

The functions of the first model learning unit 11, the second model learning unit 12, the first prediction unit 13, the second prediction unit 14 and the presentation unit 15 in the transaction price prediction device 1, may be implemented partly by dedicated hardware and partly by software or firmware. For example, the functions of the first model learning unit 11 and the second model learning unit 12 are implemented by the processing circuit 103 as dedicated hardware, whereas the functions of the first prediction unit 13, the second prediction unit 14 and the presentation unit 15 are implemented such that the processor 104 reads out and executes programs stored in the memory 105. In this manner, using hardware, software, firmware or any combination thereof, the processing circuit can implement the above functions.

As described above, the transaction price prediction device 1 according to Embodiment 1 can predict the execution price of power that reflects the power transaction situation on the prediction-target date/time, by using the first prediction model and the second prediction model.

Further, the transaction price prediction device 1 according to Embodiment 1 includes the presentation unit 15 for presenting the second prediction model that predicts the execution price, the buying bid volume as a prediction result and the execution price as a prediction result, so that the bidder can recognize a transaction situation which determines the execution price, and thus can judge the adequacy of the prediction result.

Further, in the transaction price prediction device 1 according to Embodiment 1, the first prediction unit 13 predicts the buying bid volume on the prediction-target date/time, by applying the third information, the actual values of which can be obtained on the prediction-target date/time, to the first prediction model. The second prediction unit 14 predicts the execution price on the prediction-target date/time, by applying the third information, the actual values of which can be obtained on the prediction-target date/time, and the prediction result of the buying bid volume, to the second prediction model. This makes it possible to objectively check the adequacy of the prediction result according to each prediction model, by using the actual values on the prediction-target date/time.

For example, when a check result is obtained that an error between a prediction value obtained by the application of the third information to the prediction model, and a value obtained by the application of actual values on the prediction-target date/time, namely the actual values about items of the condition that are the same as those of the third information, to the prediction model, exceeds an allowable range, the reason why the predicted transaction price is incorrect is investigated.

With respect to the reason why the prediction value about the transaction price is incorrect in the transaction price prediction device 1 according to Embodiment 1, a case, for example, is firstly investigated as a reason (1) where the predictions after the demand prediction are incorrect because of an incorrect weather forecast. When the weather forecast is correct, a case is investigated as a reason (2) where the prediction of the buying bid volume is incorrect because the first prediction model has a problem. When the prediction of the buying bid volume by the first prediction model is correct, a case is investigated as a reason (3) where the prediction of the execution price is incorrect because the second prediction model has a problem. When the prediction of the execution price by the second prediction model is proper, whether or not the error of the execution price becomes large due to non-continuous stepwise variation of the execution price relative to the buying bid volume as shown in FIG. 4, is investigated as a reason (4).

In the conventional prediction of the transaction price, only a prediction model for predicting a transaction price directly from the air temperature or the like is generally used, so that what is investigated is merely the reason shown with (1) and a mixed state based on the reasons shown with (2) to (4). In contrast, in the transaction price prediction device 1 according to Embodiment 1, the first prediction model for predicting the buying bid volume and the second prediction model for predicting the transaction price by using the prediction value of the first prediction model are used, so that it is possible to investigate, in particular, the reasons shown with (3) and (4), and thus to make more precise investigation. For example, in the case where the prediction value about the buying bid volume predicted by the first prediction model is determined not to have a problem, the information inputted to the second prediction model and the information outputted from the second prediction model are investigated, so that, when the prediction value about the transaction price is determined to be found in a range deviated from the past actual values of the transaction prices with the same condition, it is possible to determine that a large error has occurred in the transaction price because of the reason shown with (3). In this case, the narrowing condition of data used for learning the second prediction model is revised, and then relearning is performed. This makes possible a highly-accurate prediction of the transaction price.

Furthermore, the transaction price prediction device 1 according to Embodiment 1 visualizes the second prediction model, the prediction value about the buying bid volume and the prediction value about the execution price, and performs presentation so that the process of deriving the probability distribution of the execution price from the probability distribution of the buying bid volume of power by using the second prediction model is recognizable. Accordingly, the bidder can recognize the process of deriving the prediction value about the execution price, and thus can judge the adequacy of the prediction result.

It is noted that, in the description so far, a case has been described where the commodity subject to transaction price prediction is electric power; however, the transaction price prediction device 1 according to Embodiment 1 is also applicable to a commodity other than electric power so far as it is a commodity for which selling and buying bids are performed in a market.

It should be noted that this invention is not limited to the foregoing embodiment, and modification of any component in the embodiment or omission of any component in the embodiment may be made, without departing from the scope of the invention.

### INDUSTRIAL APPLICABILITY

The transaction price prediction device according to this invention is applicable, for example, to a system for predicting the execution price of power in a wholesale electric power market in which bid trends of power are not open to the public, because it is possible to reflect a transaction situation on the prediction-target date/time and to judge the adequacy of the prediction result of the transaction price.

### REFERENCE SIGNS LIST

1: transaction price prediction device, 2: first information acquisition unit, 3: first information storage unit, 4: second information acquisition unit, 5: second information storage unit, 6: third information acquisition unit, 11: first model learning unit, 12: second model learning unit, 13: first prediction unit, 14: second prediction unit, 15: presentation unit, 30: first prediction model, 40: second prediction model, 40A: prediction value, 50, 70: probability distribution, 60: stripe area, 100: first interface, 101: second interface, 102: third interface, 103: processing circuit, 104: processor, 105: memory.

1. A transaction price prediction device, comprising:
processing circuitry
to predict a buying bid volume on a prediction-target date/time, by applying a prediction value about a condition influential on demand on the prediction-target date/time to a first prediction model for predicting a buying bid volume on a basis of a correlation between a buying bid volume and the condition influential on the demand;
to predict a transaction price on the prediction-target date/time, by applying the predicted buying bid volume on the prediction-target date/time and the prediction value about the condition influential on the demand on the prediction-target date/time to a second prediction model for predicting a transaction price;
to learn a prediction model which predicts a buying bid volume matched with the prediction value about the condition influential on the demand, as the first prediction model, by using information including actual values of respective buying bid volumes and information including actual values about the condition influential on the demand; and
to learn a prediction model which predicts a transaction price matched with both a prediction value of a buying bid volume and the prediction value about the condition influential on the demand, as the second prediction model, by using information including the actual values of the respective buying bid volumes, actual values of respective transaction prices and the actual values about the condition influential on the demand.

2. The transaction price prediction device of claim 1, wherein the processing circuitry presents the second prediction model, the predicted buying bid volume on the prediction-target date/time, and the predicted transaction price on the prediction-target date/time.

3. The transaction price prediction device of claim 1, wherein the second prediction model predicts the transaction price in a form of a probability distribution.

4. The transaction price prediction device of claim 1, wherein the processing circuitry selects, using at least one of the actual values about the condition influential on the demand, the information to be used for learning the second prediction model.

5. The transaction price prediction device of claim 2, wherein the processing circuitry calculates a probability distribution of the transaction price on the prediction-target date/time, and
wherein the processing circuitry presents the calculated probability distribution of the transaction price.

6. The transaction price prediction device of claim 5, wherein the processing circuitry presents the probability distribution of the transaction price together with the second prediction model.

7. The transaction price prediction device of claim 6, wherein the processing circuitry calculates a probability distribution of the buying bid volume on the prediction-target date/time, and
wherein the processing circuitry presents the calculated probability distribution of the buying bid volume.

8. The transaction price prediction device of claim 7, wherein the processing circuitry visualizes the second prediction model by plotting, on a graph, a relationship between the buying bid volumes and the transaction prices used for calculating the second prediction model, and
puts, on the graph where the second prediction model is visualized, the calculated probability distribution of the buying bid volume and the calculated probability distribution of the transaction price,
thereby visualizing a correspondence relationship between the second prediction model, the probability distribution of the buying bid volume and the probability distribution of the transaction price.

9. A transaction price prediction method, comprising:
predicting a buying bid volume on a prediction-target date/time, by applying a prediction value about a condition influential on demand on the prediction-target date/time to a first prediction model for predicting a buying bid volume on a basis of a correlation between a buying bid volume and the condition influential on the demand;
predicting a transaction price on the prediction-target date/time, by applying the predicted buying bid volume on the prediction-target date/time and the prediction value about the condition influential on the demand on the prediction-target date/time to a second prediction model for predicting a transaction price;
learning a prediction model which predicts a buying bid volume matched with the prediction value about the condition influential on the demand, as the first prediction model, by using information including actual values of respective buying bid volumes and information including actual values about the condition influential on the demand; and
learning a prediction model which predicts a transaction price matched with both a prediction value of a buying bid volume and the prediction value about the condition influential on the demand, as the second prediction model, by using information including the actual values of the respective buying bid volumes, actual values of respective transaction prices and the actual values about the condition influential on the demand.
